(19) United States
(12) Patent Application Publication
(10) Pub. No.: US 2021/0247081 A1
(43) Pub. Date: Aug. 12, 2021

(54) Various embodiments of a plant air purifier with a filter container that holds filter material, which lets air pass through the filter material during its air purifying phase, and lets water submerge that same filter material during the remoisturiziation phase

(71) Applicants: Martin MITTELMARK, Saratoga Springs, NY (US); Joel LALICKI, Troy, NY (US)

(72) Inventors: Martin MITTELMARK, Saratoga Springs, NY (US); Joel LALICKI, Troy, NY (US)

(21) Appl. No.: 17/276,250

(22) PCT Filed: Sep. 16, 2019
(86) PCT No.: PCT/US19/51346

§ 371 Date: Mar. 15, 2021

Related U.S. Application Data
(60) Provisional application No. 62/739,167, filed on Sep. 29, 2018.

(51) Int. Cl. F24F 3/16; B01D 53/85; B01D 46/00; A01G 24/42; A01G 31/02

(52) U.S. Cl. CPC F24F 3/16; B01D 53/85; B01D 46/0035; B01D 2279/65; A01G 24/42; A01G 31/02; B01D 46/0028

(57) ABSTRACT

A plant air purifier with filter material within a filter bed container, wherein the filter material can both allow air to pass through it during the unit's air purification phase and for water to submerge the filter material during its remoisturization phase The unit itself passes through various phases and sub phases: an air purification phase; followed by a remoisturization phase, which includes an immersion of the filter material sub phase, and a draining away of the water during its drainage sub phase. And in some cases, a soaking sub phase of the filter material for some time. Three different embodiments of the unit are provided: a unit with a separate soaking; chamber outside the unit; one with an outer pot surrounding the filter container; and one with a flapper below the filter bed container.

### CROSS-REFERENCE TO RELATED APPLICATIONS

This application claims priority benefit of provisional application U.S. 62/739,167 filed Sep. 29, 2018.

### BACKGROUND OF THE INVENTION

Plant air purifiers, or phytofilters, are air purifying devices, wherein a living plant(s) is growing within the filter medium through which air passes during the air purifying process. They have been around for more than 30 years. With most of these having a filter bed that contains artificial soil; a plant growing within that filter; an air moving mechanism—usually a fan, that pulls or pushes air through the filter; and some means of remoistening the filter, which is necessary because moisture is continually sucked from the filter material as air passes through during its air purification phase.

Now in almost every case the filter is moistened during its remoisturization phase, by manual watering from the top down; wicking from a reservoir below; or by water passing through a sprinkler system situated on or above the top of the filter bed; followed by that same water draining through the filter material and often returning to a reservoir. Or finally remoisturization might occur by attaching conduits to a water supply such as that coming through the community's water system. But each of these methods of remoisturization has at least one drawback, and they are as follows:

Where one waters from the top down, leaves of the plant(s) growing in the filter bed often deflect the water which leads to uneven remoisturization;

Where a reservoir is expected to replenish moisture through wicking, this method is substantially ineffective because the wicking properties of artificial soil, used in the plant air purifier, is extremely low:

If tapers extend from the reservoir to deep within the filter, this too is ineffective since moisture though wicked up by the tapers does not extend laterally for any distance given the low wicking ability of the artificial soil in which the wicks are placed;

Where sprinklers are employed, this require sufficient water pressure for the sprinklers to operate, often provided by a powerful pump, which causes water from the water jets to extend beyond the filter container's boundaries, especially when the filter container itself is rather small, creating a good chance of water damage to surrounding furniture; plus plant stems can deflect particular jet streams of water so parts of the filter may be entirely missed in the remoisturization process, including of course uneven subsurface remoisturizing as water drains through the filter material where it may encounter roots or other obstacles;

Lastly, hooking into a public water supply means that the water used for remoisturization contains chlorine or chloramines, as mandated by law due to public health concerns. These kill friendly microbes that live close to the plant(s) roots within the filter container and are needed to bio-regenerate the filter material. The present invention with its unique method of remoisturization overcomes all of these drawbacks.

### SUMMARY OF THE INVENTION

The invention is a plant air purifier which incorporates a filter bed container wherein is housed filter material, material that lets air pass through it during the unit's air purifying phase. Plus, it lets water submerge at least some of the filter material, during its remoisturizing phase. After which excess water within the filter bed then drains away so that only a thin layer of moisture remains to encircle each filter granule before the air purification phase begins anew. In this way all parts of the filter material throughout the filter container are evenly remoistened.

This is an entirely different approach from what is practiced today and easily overcomes all the drawbacks mentioned above evident in previous models. Plus, it allows for remoisturization where replenishing of depleted levels of moisture within the filter material occurs, without muss or trouble. Further, by adding an additional sub phase to remoisturization, that of soaking, even the inner cavities of the filter material may fill with moisture, allowing the unit to purify room air and allow it to operate in the purification phase for a longer period of time before remoisturization need occur again. Within this patent application are 3 different embodiments of this type of a plant air purifier:

First, a plant air purifier, or phytofilter, where the filter container is actually removed from the air purifier during remoistening and deposited in a soaking chamber filled with water, which causes water to rise within the filter container and remoisten the filter material therein, followed by draining of that same filter container once it is removed from the soaking chamber, after which the filter contain is replaced back into the plant air purifier once more;

Second: a design where the filter container is housed within a larger container, or outer pot, within the air purifier which then fills with water, so filling the filter container as well, followed by draining away of the water in both containers which returns to a reservoir, &

Third; a unit where the filter container within the air purifier has a flap on its bottom which can rise up and enclose the porous filter bottom of the filter container so water can rise within the filter container; after which water then drains away, followed by the flap being lowered, so air may pass through the filter container once again.

In all 3 embodiments of this plant air purifier presented here, the method of operation is the same, where each unit goes through various phases of operation: an air purification phase where filter material being housed within the filter container, has air passing through it, moved by an air moving mechanism, until the filter material is in need of remoisturization; whereupon air movement, by the air moving mechanism ceases; followed by a remoisturizing phase where there is an immersion sub phase, and water is rising in the filter container until it submerges most if not all of the same filter material; followed by a draining sub phase where water within the filter container is draining from the filter container, leaving only a thin film of moisture remaining on the individual filter granules; followed again by the air purification phase once more occurring, so room air is passing through said filter material by means of the air moving mechanism and is exiting the unit as purified air.

These three embodiments of a plant air purifier will be gone into in more detail in the figures to follow, and in some of those figures, an additional sub phase of operation is added, a soaking sub phase, which allows for prolonged submersion of the filter material so that the inner cavities of the filter material may be filled with moisture over time as the filter material sits submerged.

### DESCRIPTION OF THE DRAWINGS

FIG. 1 is a circular schematic showing the various phases and sub phases of the invention's operation.

FIG. 2 is a side interior view of the 1^{st} embodiment off the plant air purifier in its air purification phase.

FIG. 3 is a side interior view of the 1^{st} embodiment's plant air purifier's top-filter container being immersed in a soaking chamber during the unit's immersion sub phase.

FIG. 4 is a side view of the top-filter bed container, resting in the soaking chamber during its soaking sub phase.

FIG. 5 is a side view of the top-filter container of the first embodiment of the plant air purifier being held over the soaking chamber and draining into it during its draining sub phase.

FIG. 6 is a top down view of the top-filter container of embodiment 1 resting at an angle on a support within a draining tray as further draining continues.

FIG. 7 is a side view of the various components of the 1^{st} embodiment of the plant air purifier during an exchange of filter-top containers.

FIG. 8 is a side interior view of embodiment 1 of the plant air purifier after the substantially drained top-filter bed container is replaced hack into outer housing of the unit, while a few drops of water continue to fall from the filter bed container itself.

FIG. 9 is a side interior view of Embodiment 2 of the plant air purifier.

FIG. 10 is a side interior view of embodiment 2 of the plant air purifier during its air purification phase.

FIG. 11 is a side interior view of embodiment 2 of the plant air purifier during its immersion sub phase.

FIG. 12 is a side interior view of the 2^{nd} embodiment of the plant air purifier during its soaking sub phase.

FIG. 13 is a side interior view of the 2^{nd} embodiment of the plant air purifier during its draining sub phase.

FIG. 14 is another side view of the 2^{nd} embodiment of the plant air purifier during its draining sub phase where an electronically controlled water shut off valve is incorporated within the unit.

FIG. 15 is a side interior view of the 3^{rd} embodiment of the plant air purifier during its air purification phase where a flapper is employed.

FIG. 16 is a side view of the 3^{rd} embodiment of the plant air purifier during its immersion sub phase.

FIG. 17 is a side interior view of the 3^{rd} embodiment of the plant air purifier during its soaking sub phase where an electronically controlled water shut off valve is employed.

FIG. 18 is a side view of the 3^{rd} embodiment of the plant air purifier during its soaking sub phase where a weep hole and drainage line is employed.

FIG. 19 is a side view of the 3rd embodiment of the plant air purifier during its draining sub phase.

FIG. 20 is another side view of the 3^{rd} embodiment of the plant air purifier during its draining sub phase, but where an electronically controlled water shut off valve is employed.

FIG. 21 is a front view of the 2^{rd} embodiment of the plant air purifier with its undercarriage being lowered into a detachable reservoir.

FIG. 22 is a front view of the plant air purifier.

FIG. 23 is a top down view of the remote control used to control the plant air purifier from a distance.

### FIGURE KEY

1. Plant air purifier
2. Air purification phase
3. A remoisturization phase
4. An immersion sub phase
5. An optional soaking sub phase
6. A draining sub phase
7. A circle showing the cycle of operation ever renewing
8. The direction of flow from one phase to the next
9. Top of the plant air purifier
10. Filter bed container
11. Combination top of the plant air purifier and filter bed container
12. Outer housing of the plant air purifier
13. Interior lip
14. Filter material
15. Air moving mechanism
16. Activated carbon
17. Expanded shale
18. Expanded clay
19. Diatomaceous earth
20. Plant
21. Fan
22. Diffusing vent
23. Purified air
24. Air stream
25. Room air
26. Porous bottom of the filter container
27. Mesh screen
28. Small filter granules
29. Moist
30. Thin film of moisture
31. Soaking tank (a water line on the interior of the soaking chamber should be added)
32. Water
33. Upward arrows
34. Submerged filter material
35. Water level of water in soaking chamber and filter container
36. Handles on the soaking chamber
37. Top of the filter material
38. Hollow cavities of the filter material
39. 45-degree angle
40. Exit point on the filter bed container
41. Draining water
42. Draining tray
43. Edge of the top of the filter bed container
44. Side of the filter bed container
45. Raised support
46. Bottom of the filter container
47. Soaking chamber top lip
48. Filter bed container coaster
49. Substantially dry filter bed
50. Remoisturized filter bed
51. Table
52. Protective fan casing
53. Electrical connections
54. Fan casing sloping top
55. Catch basin
56. Moisture screen
57. Circuit board with a timer
58. Outer pot
59. Level sensor
60. Reservoir
61. Water pump
62. Reservoir water level sensor
63. Water line
64. Electrical water shut off valve
65. Passageway between the outer surface of the filter bed container and the inner surface of the outer pot
66. Underside of the plant air purifier top
67. Path air takes through the filter container
68. Path air takes through the passageway
69. Outer pot's bottom interior
70. Water level A
71. Water level B
72. A point within 10% of the total height of the filter material within the filter bed container
73. Plant roots
74. Weep hole
75. Drainage line
76. Return arrow showing direction of water flow through drainage line
77. Flap
78. Hinge
79. Mechanical lifting and lowering device
80. linear actuator
81. rod
82. wire
83. nonporous outer cover to the filter bed container's bottom
84. undercarriage
85. dangling columns of undercarriage
86. hanging platform of the undercarriage
87. legs of the undercarriage
88. detachable reservoir
89. reservoir window
90. reservoir water level
91. red part of the window
92. front of the plant air purifier
93. infrared sensor
94. on-off switch
95. red light LED
96. a series of green lights
97. a green light to indicate ¼ speed of the fan
98. a green light to indicate ½ speed of the fan
99. a green light to indicate ¾ speed of the fan
100. a green light to indicate full speed of the fan
101. Remote control
102. On-off function button on the remote control
103. Fan lowering speed button on remote control
104. Fan increasing speed control button on remote control

### DETAILED DESCRIPTION OF THE INVENTION

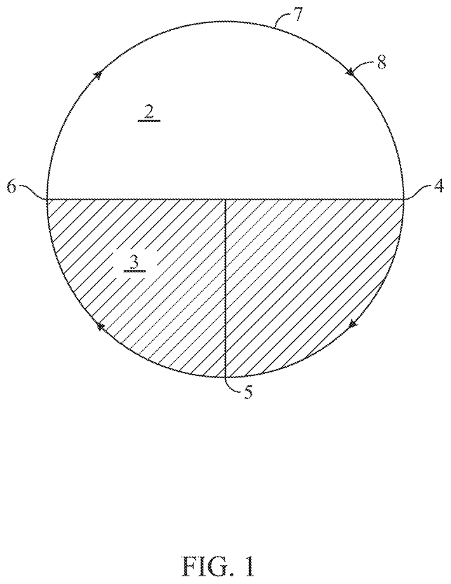

FIG. 1 shows the various phases this type of plant air purifier goes through as it operates: namely air purification (2), followed by remoisturization (3), with remoisturization being displayed as the shaded portion of a circle. Plus, the figure shows the various and different sub phases of remoisturization, which include immersion of the filter bed (4), an optional phase of soaking (5), and finally draining (6).

Air purification (2) occurs when room air passes through the unit's filter material and exits as purified air. This phase continues until the unit can no longer function as a wet scrubber, or when the unit reaches a point where air passing through the filter is actually drawing moisture from the root system of the plant(s) growing within the filter material in the filter container of the unit itself.

During the unit's air purification phase (2), the unit's filter material is growing ever drier as air continues to pass through it and from which it is absorbing moisture, until a point is reached when it is no longer operating at peak efficiently, after which the unit then shifts either manually or automatically, to its next phase, namely remoisturization (3) and the air movement mechanism is shut down, followed by the filter material being immersed in water and submerged during the immersion sub phase (4). Here water is rising in the filter bed container and first covering some of the filter material, then at least a majority of the filter material, then at least 65%, then at least 75%, then at least 90% and finally all of the filter material within the unit. This sub phase (4) is often followed by an optional sub phase, a soaking sub phase (5,) where the filter material is soakings, so allowing the filter material's inner cavities time to absorb additional water; followed then by a draining sub phase (6) where the water within the filter container is draining away and more and more of the submerged filter material is becoming exposed, until only a thin film of moisture is surrounding each granule of the filter material . After which the cycle repeats and air purification is taking place once more.

A circle surrounds the various phases and sub phases in the figure, and this circle portrays a never-ending cycle of operation (7), while arrows along the circle indicate the flow or steady progression of operation from one phase and one sub phase to the next (8).

Based on this figure the plant air purifier is employing a method where it is dividing up remoisturization into various sub phases: immersion and draining of the filter bed. Plus, an additional sub phase of soaking.

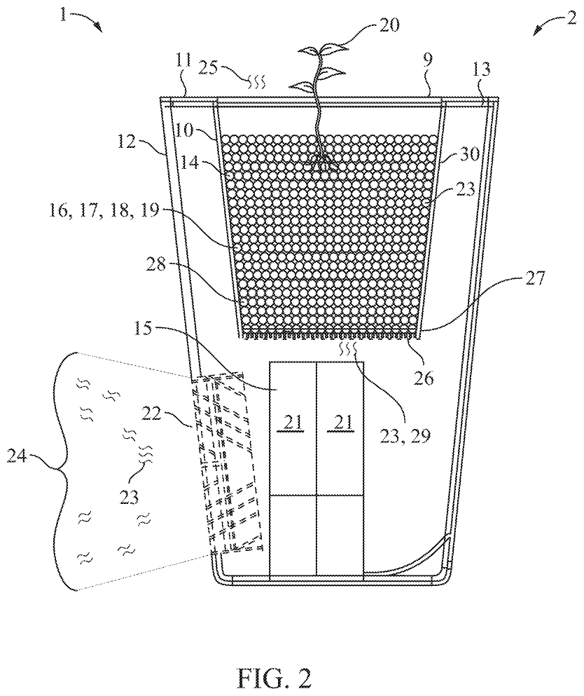

FIG. 2 shows the 1st embodiment of the air purifying device, known as a plant air purifier (1), or phytofilter, as it is functioning in the air purification phase (2), or while it is purifying air. Here the plant air purifier (1) has a top (9) and a filter bed container (10) which together are combining and are designated as a top-filter bed container (11) allowing for easy removal from the air purifier and easy attachment thereon, mainly for the sake of outside remoistening of the filter material held within the filter container, and it can simply be lifted off the rest of the unit so remoistening can be occurring in an outside soaking chamber. Now the top filter bed containing (11) is sitting atop the outer housing of the air purifier (12) and is kept in place by an interior lip (13) which slips into the interior of the outer housing. creating a substantially airtight fit; made tighter still by the weight of the filter material (14) within the filter bed container. During the unit's air purification phase (2), air is being drawn through the filter bed container and filter material by means of an air moving mechanism (15), or in the alternative is being propelled through by means of such a device. By air moving mechanism, the mechanism could comprise any of the following: blowers, centrifugal fans, axial fans, positive displacement pumps, centrifugal pumps, roto dynamic pumps, screw pumps, piston pumps, flexible vain pumps, sliding pumps, circumferential piston pumps, flexible impellers, diaphragm pumps or any other mechanism similar thereto. Now the filter material within the filter bed container (10) might be activated carbon (16), expanded shale (17), expanded clay (18), and or diatomaceous earth (19), any of which can be used by itself or in combination with some of the others already mentioned, but other ingredients might be used as well; and growing within this filter material is a plant (20).

In this embodiment of the plant air purifier and in the next two the air moving mechanism (15) is a fan (21) which is moving air both through the filter container and the filter material during the unit's air purification phase, though here there are two fans, being stationed one right in front of the other which are increasing static pressure draw, so resulting in a less powerful, less noisy, less expensive configuration than were a single, more powerful fan being employed which would need to be functioning at a higher rpm. In front of these fans is an air diffusing vent (22) which is causing less draft and making less noise than a straight direction vent. (For the sake of this patent draft is defined as being predominately directed air). In fact, with such a vent as is being employed here, at least 90% of the purified air (23) leaving the unit is extending out in an ever-widening air stream (24).

Operation of this rendition of the plant air purifier occurs when air, specifically room indoor air (25) is pulled down through the filter material (14) by the fan or fans (21) located close to the bottom of the unit itself and once there, air passes through the filter container (10) within the unit and is coming out as purified air (23). The air flow is allowed to pass through the filter container because the filter container has a porous bottom (26) which allows for air exiting from it. If air were to be pushed rather than drawn through the filter container and filter material within, the fan(s) or the air moving mechanism (15) in this figure, would have simply projected the air through, at which point the now purified air would have exited through the top of the unit instead of leaving the unit through the air diffusing vent (22) as it is here.

Meanwhile the unit has a mesh screen (27) which is placed over the porous bottom (26) so the relatively small filter granules (28) of filter material (14) do not drop from the filter bed container (10). Also, the purified air (23) coming out of the filter container is moist (29) because each granule of the filter material is coated with a thin film of moisture (30) which the air passing through the filter container absorbs. By coating each granule with a thin coat of moisture, the unit acts as a wet scrubber and when air is passing through the filter material, dust particles within this air stream are being removed when they come in contact with this film, so attaching themselves onto the moisture like film. Such pollutant particles are composed of many things—fibers, hair, dander, pollen, bacteria, mold, and result in a more effective means of air purification than were a dry filter employed.

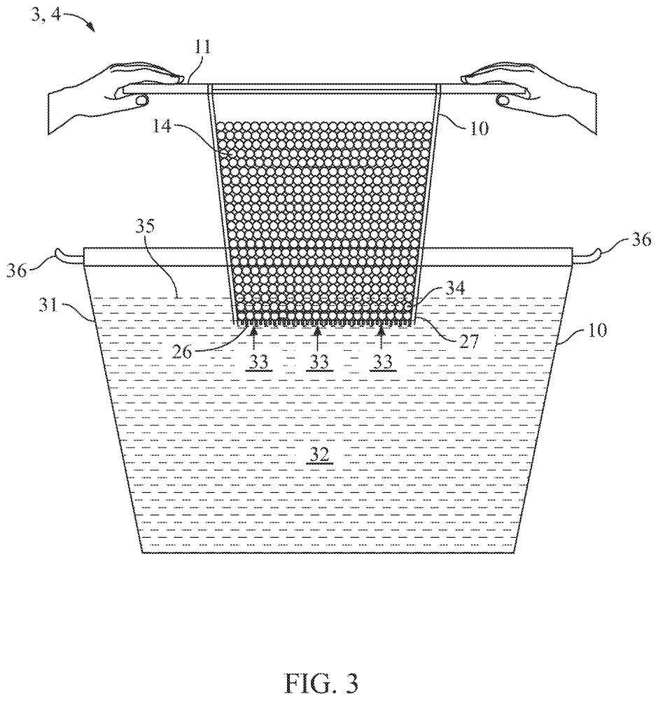

Over a period of time the amount of moisture surrounding the filter material is being depleted, since air passing through the filter bed has a lower relative humidity than the relative humidity of the filter bed, at which point the top-filter bed container (11) is lifted off the plant air purifier's outer housing (12) and immersed in a soaking tank (31) shown in FIG. 3.

This unit allows for a method for treating indoor air by way of a plant air purifier with a filter container housing filter material and for remoistening the filter material of the plant air purifier; the method comprising passing air through the filter material in the plant air purifier by means of an air moving mechanism during its air purifying phase and submerging the filter bed while remoisturizing is taking place.

FIG. 3 shows the remoisturization phase (3) of the 1St embodiment of the plant air purifier in its immersion sub phase (4) where the filter container (10) is filling with water and submerging more and more of the filter material (14) as the top-filter container (11) is being lowered into it. Here the top filter bed container component (11) is being held by someone and is in the process of being lowered into the soaking chamber (31). Now the soaking chamber is filled with water (32) and as the top-filter bed container (11) is sinking into it, water is entering the filter container (10) through its porous bottom (26). If you look at where the water level (35) is within the soaking chamber (31) you can see some of the filter material (14) in the filter container (10) is below the water level, with the result that that portion of the filter material is submerged. Meanwhile as the filter container (10) descends further and further into the soaking chamber (31) more and more water is filling its interior and more and more of the filter material (14) is being submerged as water is rising ever higher. The upward arrows (33) are indicating the upward movement of water within the filter bed container (10). Now the filter material below water level is designated as submerged filter material (34). Submerged in this patent is understood to mean, “Lying below the top surface of a body of liquid” and not simply lying below liquid poured over it from above which is merely passing through as liquid moves downward propelled by the force of gravity. Meanwhile the soaking chamber has hand grips (36) for ease of carrying if the soaking chamber is to be moved.

In summary the plant air purifier employs a method during its remoisturization phase of immersing, where more and more of the filter material within the filter container is being submerged as water rises ever higher and higher in the filter container itself.

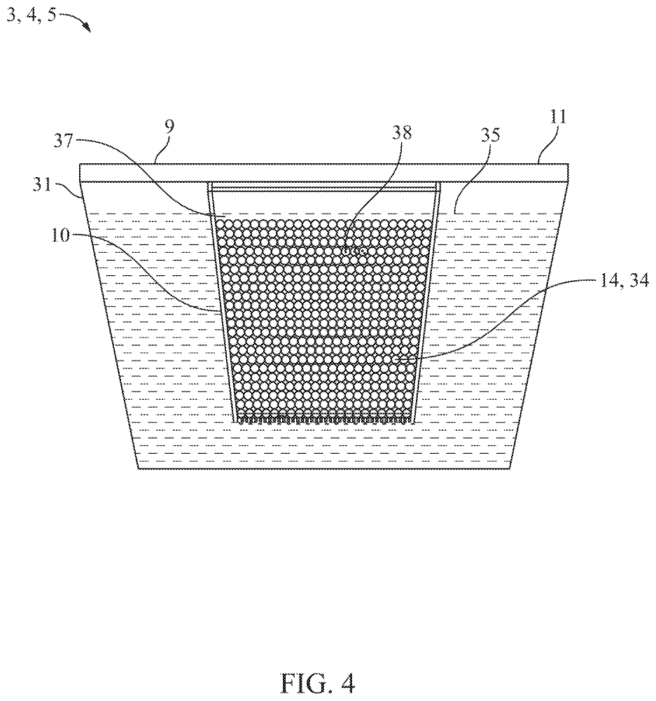

FIG. 4 shows a transition point, and marks the conclusion of the immersion stage (4) of the remoisturizing phase (3) for the 1^{st} embodiment of the plant air purifier; wherein the filter container (10) has just been lowered as far as it can go into the soaking chamber (31) with the filter container's top (9) resting on the top of the soaking chamber (31) and at this point all the filter material (14) is situated below the surface of the water (35), where the top of the filter material (37) is situated below the water's surface (35). Here, all the filter material is being submerged and is designated in the figure as submerged filter material (34). Meanwhile this figure also marks the beginning of the soaking sub phase (5) where filter material in the filter container is staying submerged for a given period of time. This sub phase begins as soon as the top of the filter container top (11) descends and is resting on the top of the soaking chamber (31), during which time the filter material's hollow inner cavities (38) are progressively filling with water.

In summary this air purifier employs a method further comprising filter material that has hollow inner cavities which are progressively filling with water over time during the soaking sub phase.

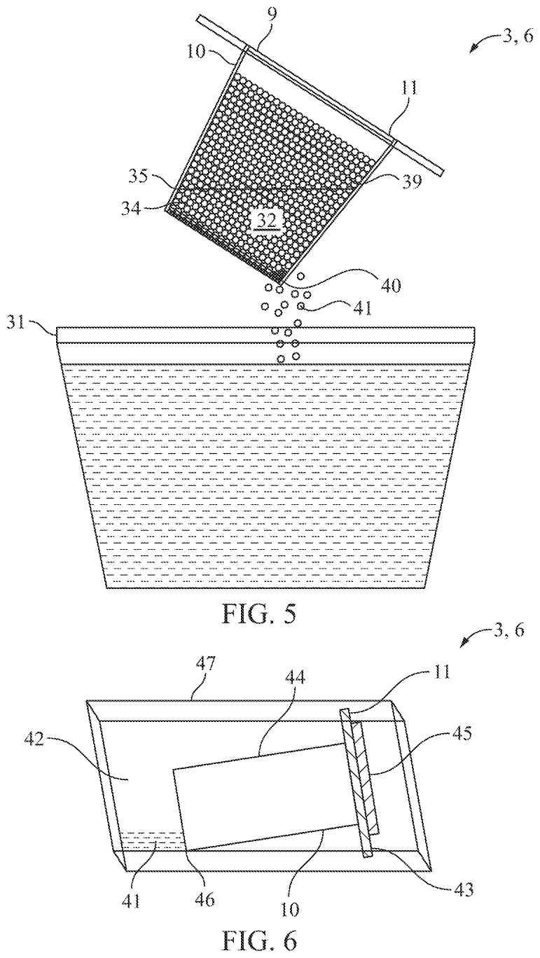

FIG. 5 shows the 1^{st} embodiment of the plant air purifier in its draining sub phase (6) during remoisturization (3). Here the filter container top (11), having been lifted off the soaking chamber (31) is now suspended above it at a 45-degree angle (39) where because of the angle draining speed is accelerated. Draining water (41) is dropping back into the soaking chamber, exiting from the bottom of the filter container's exit point (40) where the greatest pressure is exerted. And by being held at this angle it is insuring that when the filter container is returned to the plant air purifier and stationed in the horizontal position, pressure from water still remaining within the filter container will be less liable to leak out within the air purifier itself, which might cause damage to electrical components connections or to the unit's fan(s), given that in this embodiment of the plant air purifier, the unit has no reservoir. (32) shows water within the filter container and (35) shows the water level within that filter. Now as water is draining from the filter container the water level (35) is continuing to drop whereupon more and more of the filter material which previously was submerged is becoming exposed. (34) is pointing to filter material still submerged.

In summary, the method being utilized here is further comprising “a drainage sub phase where water in the filter container is draining away and progressively exposing more and more of the submerged filter material.”

FIG. 6 shows the 1^{st} embodiment of the plant air purifier in a later stage of draining within the draining sub phase (6) of remoisturization (3). The filter container top (11) could be held manually over the soaking chamber as in the last figure until only a few droplets of draining water are finally leaving the filter container (10), but one might get tired during such a process and so, as soon as a steady stream of exiting water ceases flowing from the top-filter container (11) it is then is placed at an angle inside of the draining tray (42). This draining tray has a raised support (45) that when the filter container is placed against it is allowing for the tilting of the filter container at a steeper angle than were no such raised support available, the result of which is that there is quicker and more efficient draining of the filter container. In such a position, the edge of the top of the top filter container (43) or its side (44) might be placed on top of the raised support (45) within the draining tray and the bottom of the filter container (46) is being stationed within the draining tray (42), so any water that continues to drain (41) from the filter container (10) does not run out onto anything on which it can do damage to. This is prevented from happening because the draining tray has a lip (47) that contains the dripping water, and once the filter container is placed there at an angle it can remain for as long as desired without causing any strain to the user or any water damage.

To summarize, this embodiment of the plant air purifier utilized a method that is further comprising a draining tray which is facilitating draining of the filter container without the user manually holding that filter container.

The unit is further comprising a draining tray with a raised support allowing for the tilting of the filter container at a steeper angle when it is being placed thereon allowing for quicker and more efficient draining of the filter container.

Further having a draining tray as described provides a place for the still draining filter container to be put, were the user to want to remove another top-filter container from off the air purifier itself and place it in the soaking chamber if the air purifier were to come with two top-filter components, so one filter container can be switched out for the other when the one in the unit has filter material needing remoistening, whereupon the other can immediately be substituted for it, one that has already been remoisturized. In a sense the draining tray acts as another set of hands.

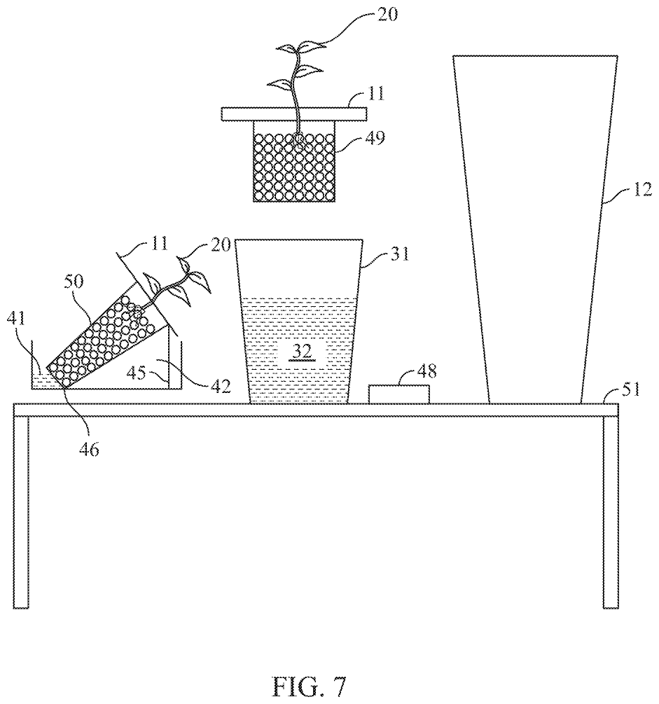

FIG. 7 shows the 1^{st} embodiment of the plant air purifier with the outer housing (12) of the unit on the far right of the figure, followed by a filter bed container coaster (48) to the left of it, on which a filter bed container top (11) can be placed so no water or dirt might mar the piece of furniture on which it is situated. Stationed to the left of the coaster is a soaking chamber (31) partially filled with water (32), enough so that when a filter container top (11) with filter material within it, shown above the soaking chamber, is placed within the soaking chamber, water will rise within the filter container to cover the filter material therein. This top-filter bed container (11) has a substantially dry filter bed (49) within it having just been removed from the air purifier housing (12) where it has been used in air purification. This top also has a plant (20), and is about to be immersed in the soaking chamber. While another top-filter bed container (11) with a remoistened filter bed (50) within it which has just been removed from the soaking chamber is resting at an angle on the soaking chamber's inner top support (45) within the draining tray (42) and is draining with draining water (41) coming out its bottom (46). This second filter bed container top also has a plant (20). All of these various components of the 1^{st} embodiment of the plant air purifier are resting on a table (51) and are in use during the switch of one plant air purifier top-filter bed container for another. In this figure are two top-filter bed containers which are being employed for easy switching out of one for the other when the one in the air purifying unit has filter material needing remoistening. By providing two such tops it makes it unnecessary to delay using the plant air purifier for air purification purposes any longer than necessary, and is allowing the air purifier to begin air purification again much quicker than were a single top alone provided.

Here is the method used to exchange filter bed container tops. It being as follows:
a. Remove the filter bed container with a substantially dry filter bed and plant from the plant air purifier unit;
b. Place that unit taken from the plant air purifier onto something like a grid or coaster so dirt or a mark is not left on the table (it is sufficiently dry that water should not drop from off of it).
c. Turn off unit.
d. Remove the filter bed container with a remoistarized filter bed with plant from the soaking chamber;
e. Drain that filter bed container at a 45-degree angle over the soaking chamber the stream flowing from it is no longer creating a steady flow but is intermittent;
f. Then place it on the draining tray at an angle and let it stay there for about a minute to continue draining in the draining tray;
g. Afterwards take the filter bed container that had been draining on the draining tray and holding it horizontal place it in the plant air purifier's outer housing;
h. Now take the soaking chamber water within the draining tray and pour it back into the soaking chamber; &
i. Finally take the filter bed container with the substantially dry filter bed that had been resting on the coaster or grid and lower it into the soaking chamber, fitting it so that its top fits snugly onto the top of the soaking chamber.
j. Turn on unit.
   Such a method of filter bed top exchange should only take about a minute

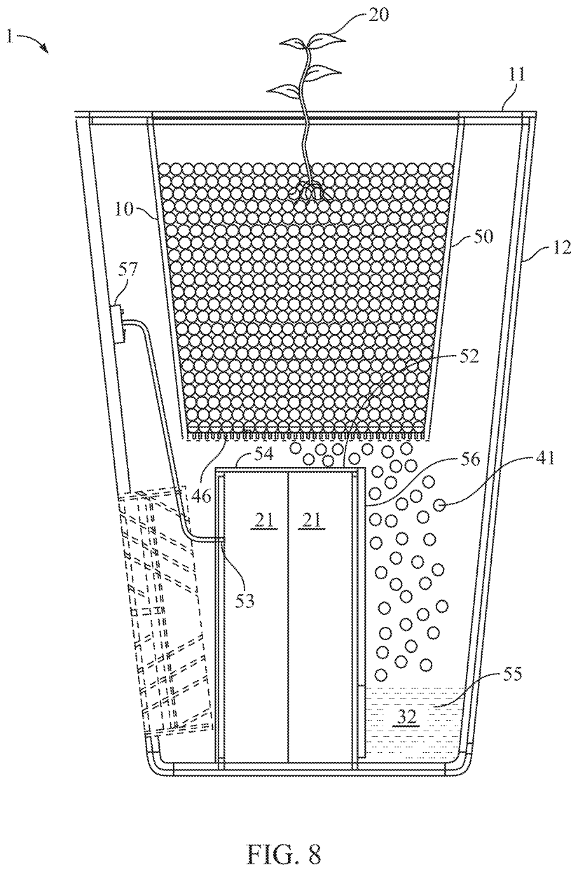

FIG. 8 returns one back to the plant air purifier (1) with the top-filter bed container (11) reinstalled onto the unit's outer housing (12) after its filter material has been re-moistened (50) and after the drainage phase has taken place, at which point there will still be a few drops of water drainage (41) occurring which will drop from the filter bed container bottom (46) onto a protective fan casing (52) which covers the fan(s) (21)) since the filter bed container (10) is stationed just above them. This fan cover is preventing dripping water droplets (31) from the filter container from doing damage to exposed wiring connections, (53) and the fan mechanism, either of which could lead to a shortened lifespan of the plant air purifier itself. Also, the top of the fan casing has a slope (54) so excess water droplets falling from the unit or fan case will fall into a catch basin (55) which can hold as much as a cup of water (32) or more. This catch basin is collecting water droplets coming off the filter bed container as the filter container is sitting within the air purifier's outer housing (12). Further there is placed upwind of the fan(s) just before them a moisture screen (56), which is preventing water droplets that are sporadically coming out of the filter container from entering the fan mechanism. Such protective measures eliminate the need for the unit to have a reservoir and eliminate worry on the part of a user about water damage to the unit after remoistening has taken place. As for when remoisturization should take place, a circuit board with a timer (57) is shutting off the unit's fan(s) after a given time, so lessening the filter material (14) becoming too dry which could be causing undo stress on the plant (20) within the unit itself.

Previously in FIG. 7, a routine was described where during the exchange of filter bed container tops, the unit was shut off, followed by it being turning on again once the exchange of tops had been completed. Turning on the unit is automatically resetting the timer within the circuit board so that after a given period of time the unit will be shutting off the fan(s) so as to protect the filter material from drying out excessively and to eliminate dry air passing through the filter material thereafter absorbing what little moisture remains within that filter bed, after which that air will then draw away moisture from the roots of the plant, causing it to go into shock. (Shock usually occurs when the plant encounters a traumatic event that might well be life threatening and causes it to become paralyzed, or immobilized in its bodily functions). Failure to turn off the fan(s) followed by turning them on again activates this safety feature which is necessary to protect the plant.

Therefore we claim a method further comprising first turning off the unit, and so turning off the fan(s), which are moving air through the filter material, followed by turning on the unit again, which is initiating the resetting of the timer, automatically programmed for shutting off the fan(s) after a given period of time; so preventing the filter material within the unit from drying out excessively, and from moisture being sucked out of the roots of the plant thereafter, that could result in the plant, being sent, into shock.

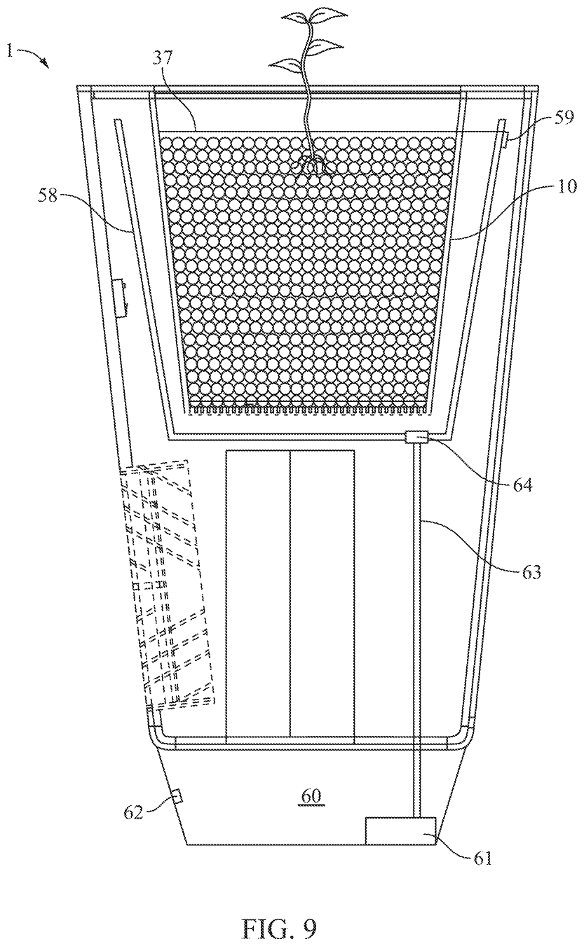

FIG. 9 provides a 2^{nd} embodiment of the plant air purifier which has the same components as FIGS. 2 & 8, but for an outer pot (58) which is substantially surrounding the filter bed container (10), a level sensor (59) is placed on that outer pot within 10% of the top of the filter material (37) as so judged by the filter material's height within the filter bed container (10), a reservoir (60) is added along with a water pump (61). Plus, sometimes there is a reservoir water level sensor (62) therein and a water line (63) which leads from the reservoir to the outer pot, coupled at times to an electrical shut off water valve (64) where the water line (63) enters into the outer pot. All of which allow the plant air purifier to have automated moisturizing capability and eliminates the need to manually remove the filter container from the unit, or soak the filter container in an outside soaking chamber, followed by draining it, before placing it once more back into the unit so that air purification can take place. But how such automation occurs will be discussed in greater detail in some of the next few figures as well as a clearer demonstration of how many of these components function.

Meanwhile, the general method utilized by some of these components within the plant air purifier, and especially the 2^{nd} embodiment are as follows:

The reservoir is sending water to the filter bed container for remoisturizing the filter material within, and receiving back excess water from the filter bed container during overflow or draining;

The water pump is pumping water into the filter bed container as remoisturizing is taking place;

The water line is connecting the reservoir and water pump to the filter bed container so immersing and draining can be taking place;

The level sensor is being stationed at a height close to the top of the filter material within the filter container and is sending a signal shutting off the water pump when water within the filter bed container is reaching one of the two conditions: a) the top of the filter material; b) a point lying within 10% of the total height of the filter material within the filter container; and

The electrically activated water shut off valve is being activated once water is reaching the level sensor, resulting in a signal being sent, closing off the return pathway to the reservoir and preventing water draining back through the water line once the water pump is being shut off.

This drawing shows the 2^{nd} embodiment of the invention where the plant air purifier, is in its air purification phase (2) or as it is purifying air. Here, the plant air purifier (1) has a top (9) and a filter bed container (10) combined which is designated as a top-filter bed container (11). This component has been designed for easy removal, for easier access to the inside of the unit from the top, and can simply be lifted off the rest of the unit. This piece sits atop the outer housing of the air purifier (12) and is kept in place by an interior lip (13) which slips into the interior of the outer housing. creating a substantially air tight fit; made tighter still by the weight of the filter material (14) within the filter bed container. During the unit's air purification phase (2), air is either drawn through the filter bed container and filter material as well, or propelled through by means of an air moving mechanism (15). Now contained within the filter container is the filter material which might be activated carbon (16), expanded shale (17), expanded clay (18), and or diatomaceous earth (19), any of which can be used by itself or in combination with some of the others, but other ingredients might be used as well; and growing within this medium is a plant (20).

Within the housing is at least one fan (21), in this case there are two fans, one set right in front of the other. Now the advantage of having two fans, in such an arrangement, is that greater static pressure draw is generated than one fan which might require more power to overcome the same static pressure, and this arrangement allows the two fans to function at a lower rpm, thus generating less noise. In front of these fans is a vent mechanism (22) where at least 90% of the air leaving is extending out in an ever-widening air stream (24) of purified air (23) so eliminating draft which might otherwise be uncomfortable and it is also cutting down on noise when the fan(s) are running.

Operation of this rendition of the plant air purifier within its air purification phase (2) occurs when room air (25) is pulled down through the filter material (14) by the fan or fans (21) located close to the bottom of the unit itself, whereupon air comes out of the unit as purified air (23). The air flow passes through the filter container (10) and exits through the filter container's porous bottom (26). The purified air coming out of the filter container is moist (29) because each granule of the filter material (28) is coated with a thin film of moisture (30) which the air passing through the filter container absorbs. By coating each granule with a thin coat of moisture, the unit is able to act as a wet scrubber as well when air passes through the filter bed. And dust particles within this air stream are removed when they come in contact with this film. Such particles are often composed of many things which can include fibers, hair, dander, pollen, bacteria, mold, etc.

The unit looks much like the previous embodiment save there is an outer pot (58) surrounding much of the filter bed container (10), but it is stationed slightly lower and is allowing immersing, draining and soaking of the filter bed material within said filter bed container without the filter container being removed from the plant air purifier itself . hi this configuration a passageway (65) is created between the outer surface of the filter bed container and the inner surface of the outer pot through which all air leaving the filter container, through its porous bottom (26) passes, after which it is drawn up toward the underside of the plant air purifier top (66), followed by it being drawn down to the fan(s) (21) situated directly under the outer pot. (67) shows the path the air takes through the filter container. (68) shows the path that air takes through the passageway between the inner and outer pots as designated by an upward arrow. Do realize this is a direct path upwards all around the filter bed container through the passageway between the filter bed container's exterior and the outer pot's interior where the air coming out of the filter container does a U turn once it leaves the porous bottom as it heads toward the top of the unit and the top of the outer pot, after which, the now purified air (23) is drawn down into the fan(s) (21) and leaves the unit through the diffusing vent (22) in its front, with at least 90% of the purified air traveling out in an ever widening air stream (24), thus creating little or no draft and lessening any noise that the fans and air flow might create. A downward arrow outside the outer pot and the curving arrow followed by the horizontal arrow going left show the course of air flow once it leaves the passageway (65) between filter container and outer pot, until it is drawn into the fans (21) and then out the vent.

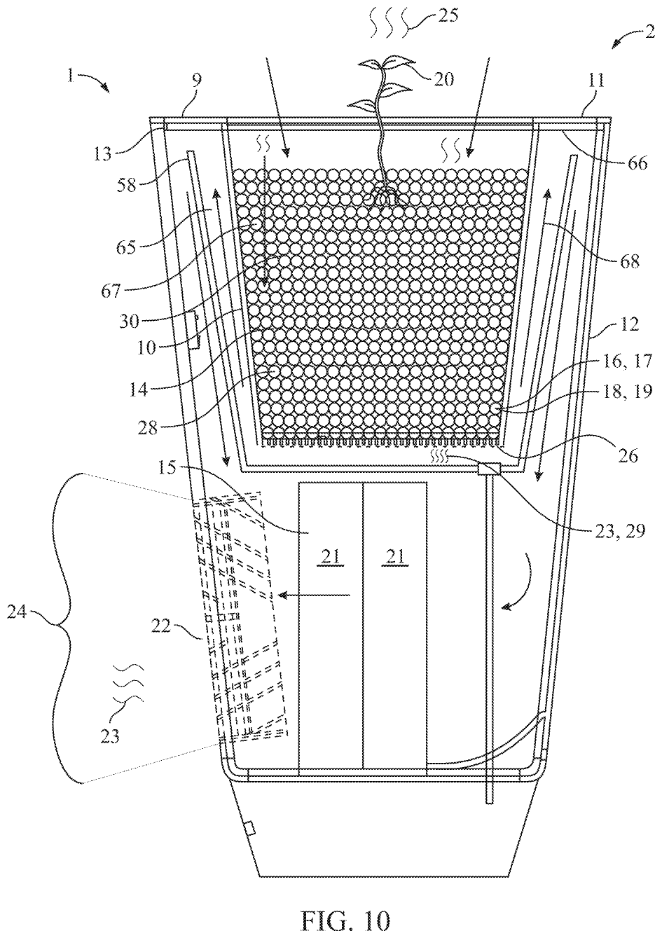

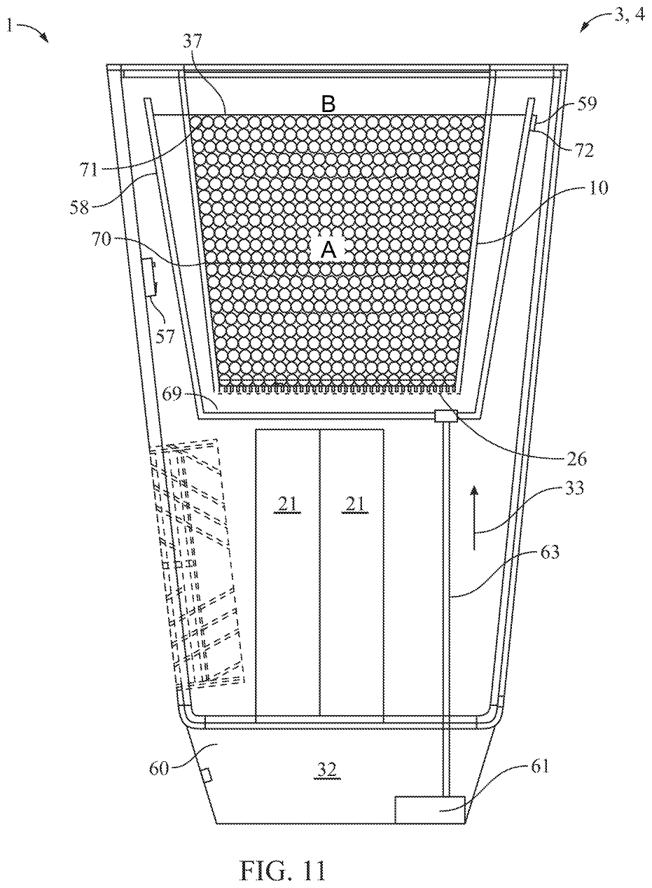

FIG. 11 shows the same plant air purifier as in FIG. 10 save the unit is now operating in its remoisturization phase (3) in the immersion sub phase ((4). At this point the fans (21) are not operating and water (32) in the reservoir (60) is being drawn up by the water pump (61) through the water line (63). An upward arrow (33) near the water line (63) indicates the direction water is flowing. Here, water first is filling the outer pot's (58) bottom interior (69) and as it is rising it passes through the porous bottom (26) of the filter bed container (10). Then continues rising in both the outer pot (58) and the filter container (10) as well. (70) shows a point in time during this process where the water level has only partially filled the filter container designated as water level A. Whereupon water keeps rising until it reaches the level sensor (59) situated on the outer pot (58), which occurs at another point in time, this height being designated as water level B (71), at which point, the sensor then is sending a signal to the circuit board (57) which subsequently is sending a signal to the water pump (61) shutting it off, whereupon it ceases to push water into the filter container and the immersing sub phase (4) concludes. Again, during this phase of operation, the water pump is pumping water to the filter bed container, and the filter bed therein, as remoisturizing is taking place

Please note that placement of the water level sensor is only approximately at the top of the filter material (37) situated in the filter bed container (10), more specifically within 10% of the total height of the filter material within the filter bed container (72). This is because the filter material is often put in manually by the user and so the top of the filter material in the filter bed container is rarely exactly where the sensor is placed. But to be clear, the level sensor (59) is stationed close to the top of the filter material for shutting off of the water pump when water is reaching one of the two following positions: a) the top of the filter material itself (37) within the filter bed container; or a point within 10% of the total height of the filter material (72) within the filter container.

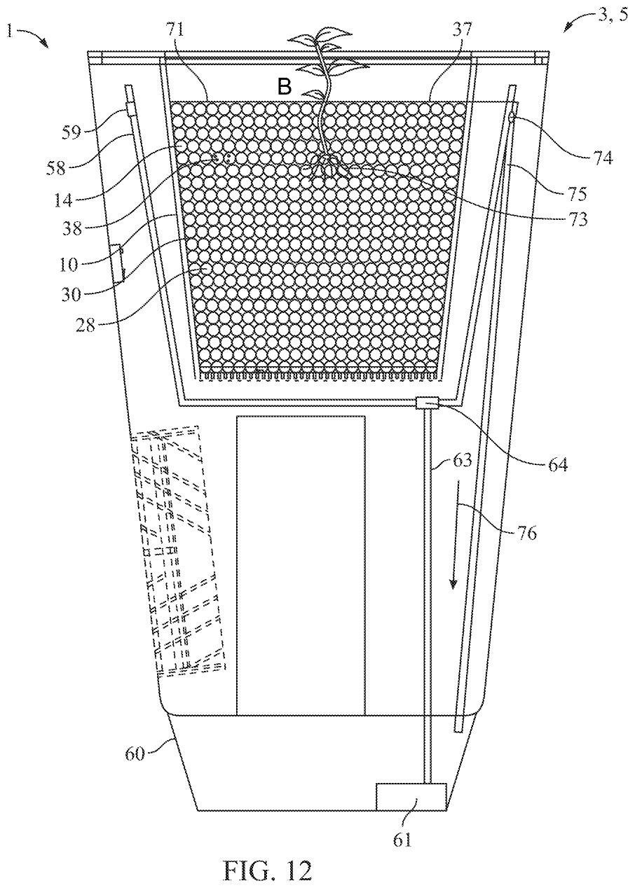

FIG. 12 Shows what takes place during the remoisturization phase (3) soaking sub phase (5) of the 2^{nd} embodiment of a plant air purifier. As mentioned earlier a soaking phase is not necessary for this unit to operate but it does provide added benefits if such a sub phase is incorporated within the remoisturization process for it allows the inner cavities of the filter material (38)1 to fill as water seeps into these cavities over time and it allows for quicker meeting of the plant's watering needs since plant roots (73) can now simply suck the moisture in directly, rather than gaining its moisture strictly from the thin film of moisture (30) on each piece of filter material (28) But to have a soaking phase one means of achieving this is to have an electrically controlled water shut off valve (64) which prevents water from draining back into the reservoir (60) through the same water line (63) which brought water into the filter bed container (10) originally through the action of the water pump (61); or in the alternative, a weep hole (74) can be stationed through the outer pot (58), somewhat parallel to the top of the filter material (37) with a drainage line (75) leading back to the reservoir (60) so when water in the outer pot reaches this level, or reaches level B (71), any water reaching the height of the weep hole will drain back to the reservoir (60) even when the water pump (61) continues to pump water into both the outer pot and the filter bed container. In fact, if the weep hole, and drainage line method are employed, there is no need for an automatic shut off valve (64) or a level sensor (59) at all, for water coming in and water returning to the reservoir continues in a steady flow, preventing overflowing. This means these mechanical parts which could break down are eliminated. A downward arrow (76) near the drainage line (75) indicates the direction of flow when weep hole and drainage line are employed and when water comes to or were to be at or higher than Level B (71).

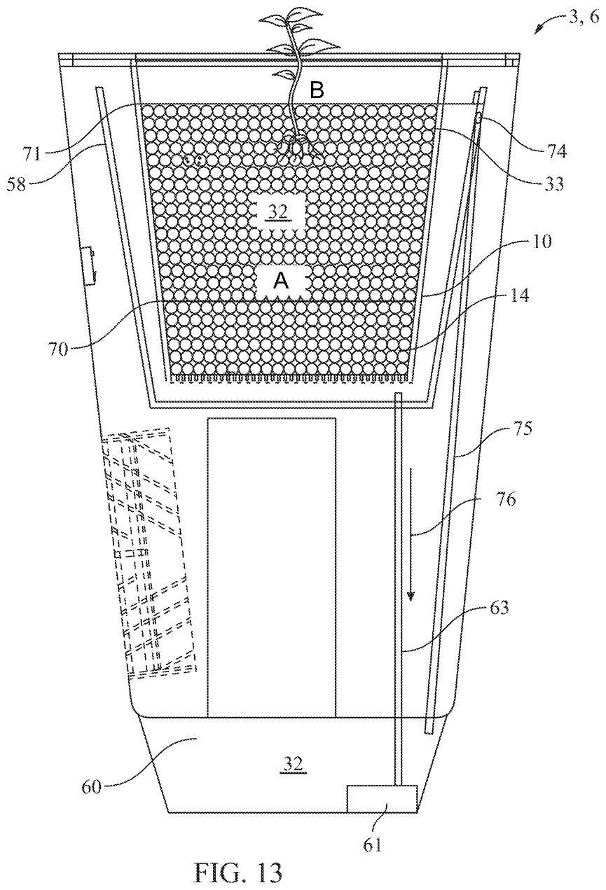

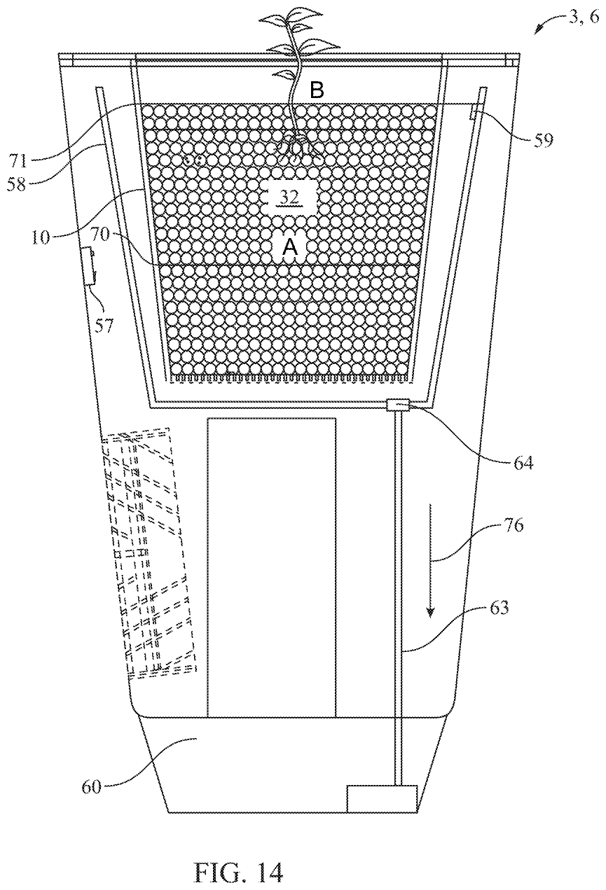

FIG. 13 shows the 2^{nd} embodiment of a plant air purifier in its remoisturization phase (3), draining sub phase (6) with water (32) in the outer pot (58) being at level B (71)). At this point, the pump (61) is now shut off, whereupon water (32) simply drains back down into the reservoir (60) via gravity through the water line (63). The water line is connecting the water pump (61) within reservoir (60) to the outer pot (58) bottom, thus allowing for both immersing and draining of the filter bed container (10) wherein filter material (14) is situated.

Level A (70) is showing a time when the draining process is underway but not complete and designates where the water level is at that point. Here in this variation there is no shut off valve installed in the water line or just above it. Plus, even if the unit had a weep hole (74) situated near level B (71) and a drainage line (75) connected thereto, the method of drainage would be the same. A down arrow (76) near the water line (63) indicates the direction of water flow that is passing through the water line itself during this phase

FIG. 14 shows the same embodiment of a plant air purifier in the remoisturization phase (3, draining sub phase (6) as in FIG. 13 but here the unit has an electronically controlled water shut off valve (64) and level sensor (59) and lacks a weep hole and drainage line. In which case the drainage process or drainage phase is initiated by a signal being sent from the circuit board and timer (57) to the electronically controlled water shut off valve (64) which had been closed and is now opened and water (32) in both the outer pot (58) and the filter container (10) simply returns to the reservoir (60) via gravity through the water line (63). (76) shows the downward arrow indicating the direction of water flow back to the reservoir through the water line itself. Level B (71) shows where the water level was at the initiation of the drainage phase. Level A (70) shows where the water is as the drainage sub phase (6) continues at a particular point in time, and this process continues until substantially all water within the filter bed container (10) and the outer pot (58) has left.

A main feature of this embodiment of the invention is that remoisturization of the filter bed is accomplished by means of a reservoir within the unit which is sending water to the filter bed container for remoisturizing of the filter material therein and receiving back excess water not being retained by the filter bed, once remoisturizing of the filter bed takes place; Plus another feature is that an electrically activated water shut off valve is being activated once water is reaching the level sensor, so closing off the return pathway to the reservoir of said water, and preventing of water draining back through the water line once the water pump is shut off.

This drawing shows the 3^{rd} embodiment of a plant air purifier during its air purification phase (2) or as it is purifying air, save that in this embodiment, as compared to the last, a flap (77) is attached to the bottom of the filter container (10) rather than an all-encompassing outer pot, and this flap is attached to the filter container by means of a hinge (78) which allows the flap to be either in an up or down position. This flap is being stationed under the porous bottom (26) of the filter bed container, the raising of which is making the bottom impervious, so allowing for a method of operation to be employed which allows for both remoisturization of the filter material within the filter container and air purification as well in a way different than other plant air purifiers have used.

Said method to include: raising the flap, thus making the bottom of the filter container impervious; filling the filter container with water, which as it is rising ever higher within the filter container is submerging more and more of the filter material; draining the filter container so more and more of the filter material is no longer being submerged; continuing draining of the filter container until all the water has drained away, lowering the flap stationed at the bottom of the filter container; moving air through the filter container by means of an air moving mechanism and so purifying indoor air. Now this flap is raised or lowered by means of a mechanical lifting device (79) here, more specifically, a micro linear actuator (80) that draws it up or lowers it according to what function the plant air purifier is to perform. Whereupon the method just described above in the preceding paragraph is further comprised of an actuator that is lifting and lowering the flap stationed under the porous bottom of the filter container.

Now the actuator is attached to the flap by means of a rod (81) or wire (82) attached to the front of the flap so the actuator may do its work. But the important point is that the actuator (80) is both lifting and lowering the flap (77), stationed under the porous bottom of the filter bed container (26), according to what function the plant air purifier is performing;

As for the plant air purifier (1) itself, it is pretty much constructed as in the last embodiment, where it has a top (9) and a filter bed container (10) combined which is designated as a top-filter bed container (11). And is designed for easy removal, for easier access to the inside of the unit from the top, and can simply be lifted off the rest of the unit. This piece sits atop the outer housing of the air purifier (12) and is kept in place by an interior lip (13) which slips into the interior of the outer housing, creating a substantially airtight fit; made tighter still by the weight of the filter material 14) within the filter bed container. During the unit's air purification phase (2), air is drawn through the filter bed container and filter material by means of an air moving mechanism (15), or in the alternative is propelled through them. Now contained within the filter container is the filter material which might be activated carbon (16), expanded shale (17), expanded clay (18), and or diatomaceous earth (19), any of which can be used by itself or in combination with some of the others, but other ingredients might be used as well; and growing within this medium is a plant (20).

Within the housing is at least one fan (21), in this case there are two fans, one set right in front of the other. Now the advantage of having two fans, in such an arrangement, is that greater static pressure draw is generated than one fan which might require more power to overcome the same static pressure, and this arrangement allows the two fans to function at a lower rpm, thus generating less noise. In front of these fans is a diffusing vent (22) where at least 90% of the air leaving is extending out in an ever-widening air stream (24) of purified air (23) so eliminating draft which might otherwise be uncomfortable and this arrangement cuts down on noise when the fan(s) are running.

Operation of this rendition of the plant air purifier within its air purification phase (2) occurs when room air (25) is pulled down through the filter material (14) by the fan or fans (21) located close to the bottom of the unit itself, whereupon air comes out of the unit is purified air (23). The air flow passes through the filter container (10) and exits through the filter container's porous bottom (26). And the flap (77) offers no impediment to this air flow when in the down position. Meanwhile, the purified air coming out of the filter container is moist (29) because each granule of the filter material (28) is coated with a thin film of moisture (30) which the air passing through the filter container absorbs. By coating each filter material granule situated within the filter container with a thin coat of moisture, it is so enabling the unit's acting as a wet scrubber during the air purification process, while air is passing through the filter.

And dust particles within this air stream are removed when they come in contact with this film. Such particles are often composed of many things which can include fibers, hair, dander, pollen, bacteria, mold, etc.

This method whereby a flap and a lifting device of that flap are used is superior to the embodiment using an outer pot in terms of less turning of the air stream during the air purification phase and so requires a less powerful air propelling mechanism since there is less static pressure to overcome, due to the fact the air stream travels directly through the filter bed container and is drawn out through the fan and vent. But with the outer pot embodiment during the air purification phase the air stream has to change direction a number of times, so increasing static pressure and so requiring a more powerful fan.

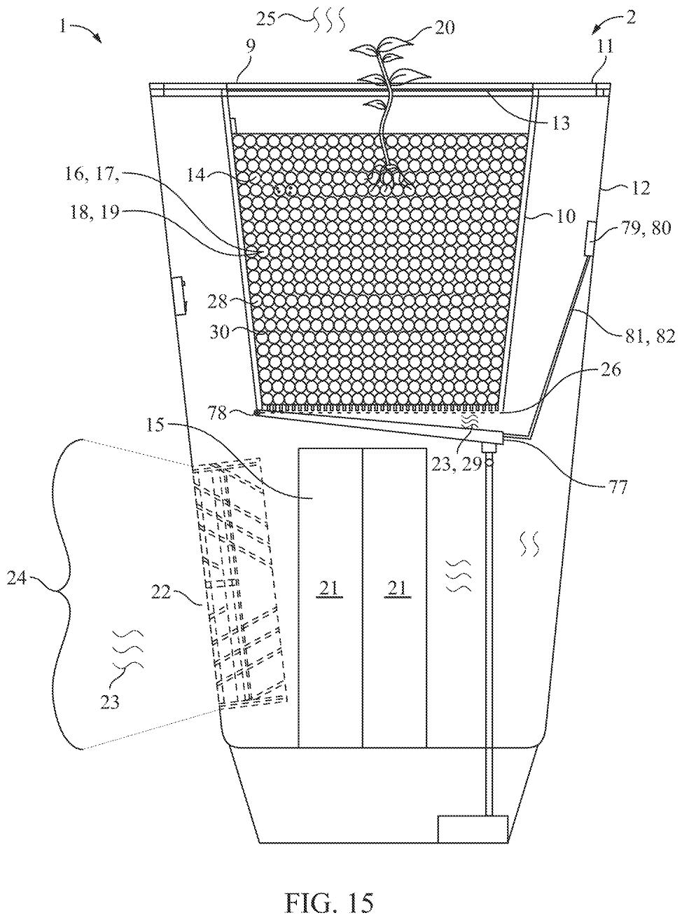

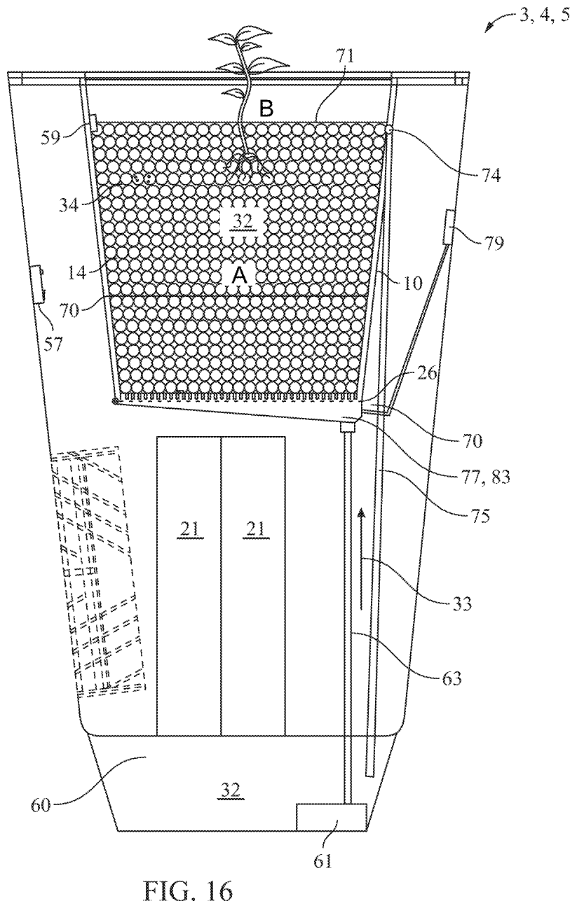

FIG. 16 shows the same plant air purifier as in FIG. 15 save the unit is now operating in the remoisturization phase (3) immersion sub phase (4). Initiation of the immersion phase occurs when a timer in the circuit board (57) shuts off the fan(s) (21) and activates the lifting mechanism (79) which raises the flap (77), so that it now covers the porous filter bed container bottom (26) with the flap serving as an a nonporous outer cover to the filter bed container (83) so that water (32) may rise within the filter container (10) itself. Whereupon water (32) in the reservoir (60) is drawn up by the water pump (61) and enters the filter container through the water line (63), which is attached to the flap (77). An upward arrow (33) near the water line (63) indicates the direction water is flowing. This water passes through the porous filter bed container bottom (26) and as the water rises submerges more and more of the filter bed material (14) A point in time during this process where the water level has only partially filled the filter container is shown by water level A (70). During this sub phase, water keeps rising until it reaches the level sensor (59) situated on the filter bed container and submerges all of the filter material (34) or substantially all of it, here designated as water level B (71), at which point, the sensor (59) then sends a signal to the circuit board (57) which sends a signal to the pump (61) so shutting it off, whereupon it ceases to push water into the filter container, so completing the immersion sub phase (4) of remoisturization (3).

In an alternative method of ending the immersing phase, one which requires no level sensor (59) or electrically controlled water shut off valve, and one which lets pumping of water by the pump (61) continue, an overflow weep hole (74) is situated close to water level B (71) in the unit so when water reaches this point it enters the weep hole and drains back into the reservoir (60) via a drainage line (75). This alternative method allows the immersion sub phase (4) and soaking sub phase (5) to become one and the soaking phase can continue for however long is desired with the timer in the circuit board (57) being programmed to end it.

Now such a method can be incorporated in either embodiment 2 or embodiment 3 and more broadly states the plant air purifier further being comprised of an overflow weep hole and drainage line that is taking water back to the reservoir so the water pump may be operating even during soaking.

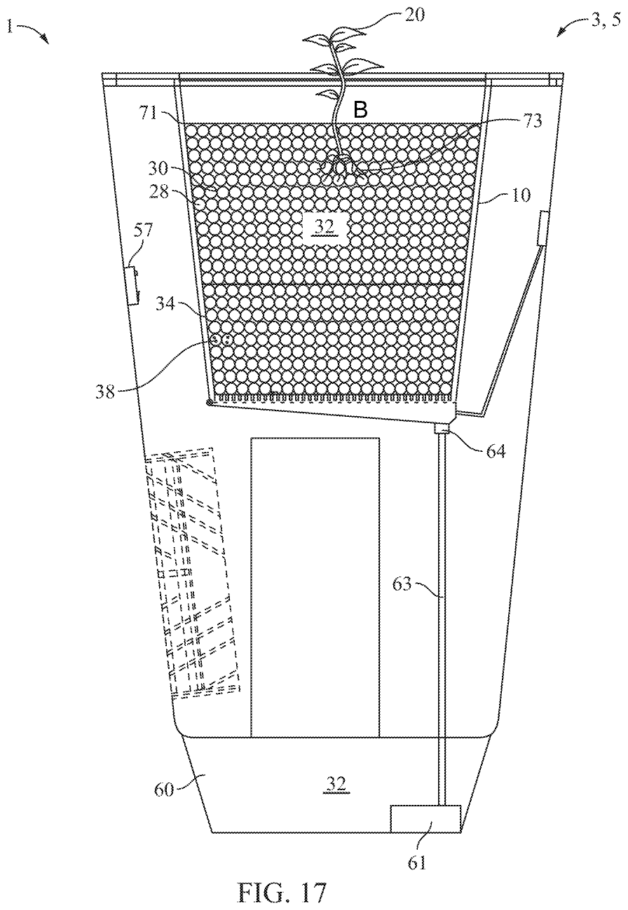

FIG. 17 shows the remoisturization phase (3) soaking sub phase (5) of the 3^{rd} embodiment of a plant air purifier where said plant air purifier (1) has an electrical automatic shut off valve. (64). (As mentioned earlier a soaking phase is not necessary for this unit to operate but it does provide added benefits if such a phase is incorporated within the remoisturization process (3) for it allows the hollow cavities of the filter material (38) to fill with water (32) which seeps in over time and allows for quicker meeting of the plant's (20) watering needs, since plant roots (73) can now simply suck the moisture in directly, rather than gain moisture strictly from the thin film of moisture (30) on each piece of filter material (28)

In this case the soaking sub phase (5) is a stationary phase for once the electrical automatic shut off valve (64) has closed off the water line (63), water (32) in the filter container (10) is now prevented from draining back into the reservoir (60) through the same water line (63) which brought it into the filter bed container (10) in the first place, the water pump (61) being off, and all the small granules of filter material (28) have become submerged (34) with said phase ending only when the circuit board with automatic timer (57) then sends a signal to the electrical automatic shut off valve (64) to reopen so water may drain from the filter container (10). Meanwhile water remains at water level B (71).

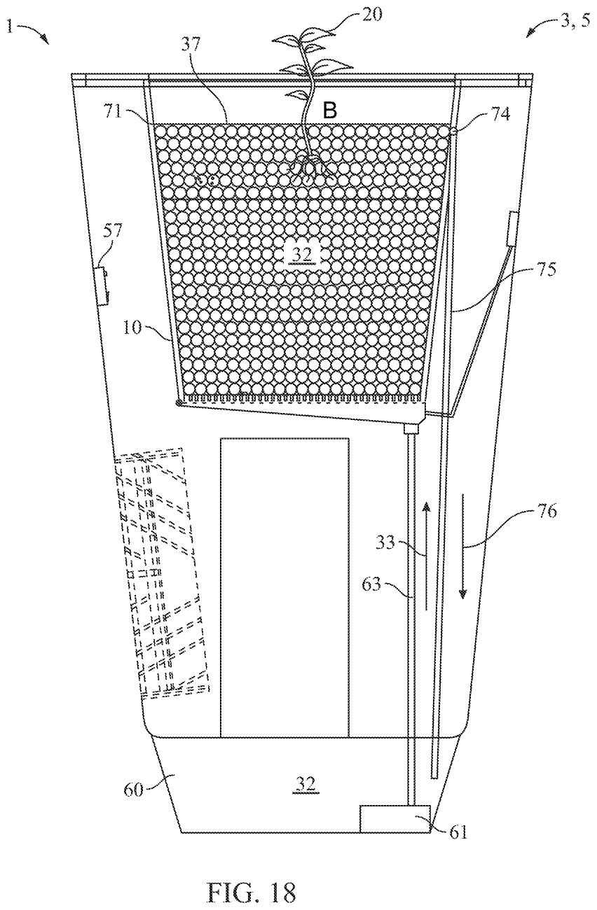

FIG. 18 shows a remoisturization phase (3) and an active soaking sub phase (5) of the 3^{rd} embodiment of a plant air purifier (1) where the unit has a plant (20) in it and a weep hole (74) placed in close proximity to water line B (71), at or near the approximate top of the filter material (37) within the filter bed container (10), and the weep hole (74) is connected to a drainage line (75) that takes the excess water back to the reservoir (60) were the water pump (61) to continue to run. In such a phase and sub phase we see water (32) in both in the reservoir (60) and the filter container (10). (33) shows the upward direction of water flow through the water line (63)) and (76) shows a downward arrow indicating the return flow of water to the reservoir (60) through the drainage line (75) with said phase continuing to operate as long as the water pump (61) is pumping water. This embodiment eliminates the need for either a water level sensor or an electrical automatic water shut off valve and so simplifies both operation of the unit by eliminating unnecessary components that might break down. Said soaking condition continues until a signal is sent from the circuit board and timer (57) to the pump (61) shutting it off. Again to clarify, in this figure there is at least one overflow weep hole and an overflow drain line, that is taking water that otherwise would rise above the approximate top of the filter material (37), back to the reservoir, so the water pump may continue operating even during the soaking sub phase of remoisturization (3)

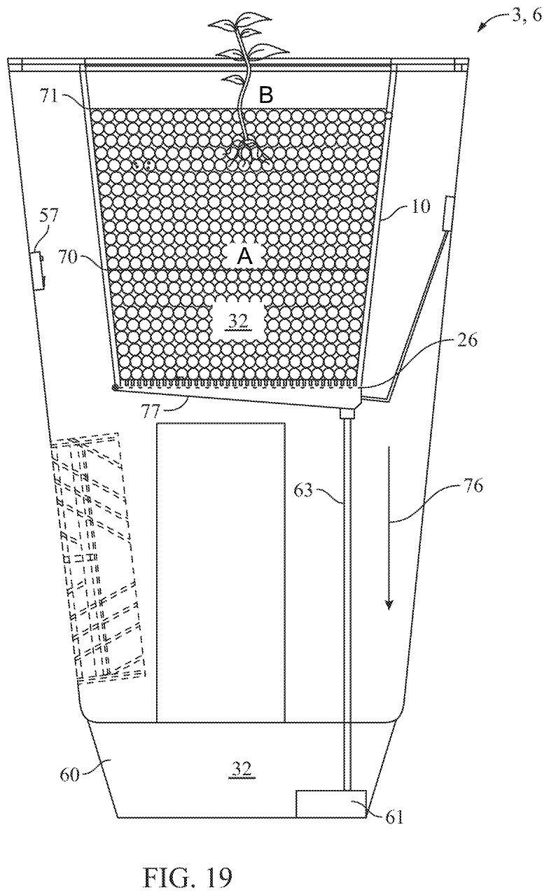

FIG. 19 shows the 3rd embodiment of a plant air purifier in the remoisturization phase (3) draining phase (6) with a flap (77) which is in the up position. Here water being at level B (71), the pump (61) is now shut off via a signal being sent from the circuit board and timer (57) to the water pump (61), where upon water (32) in the filter bed (10) simply drains back down into the reservoir (60) as a result of gravity, passing through the porous bottom of the filter container (26) through the water line (63), while a downward arrow (76) indicates the direction of flow. Level A (70) is showing a time when the draining process is underway but not complete and designates where the water level is within the filter bed (10) at that point. Here in this variation there is no electrical water shut off valve.

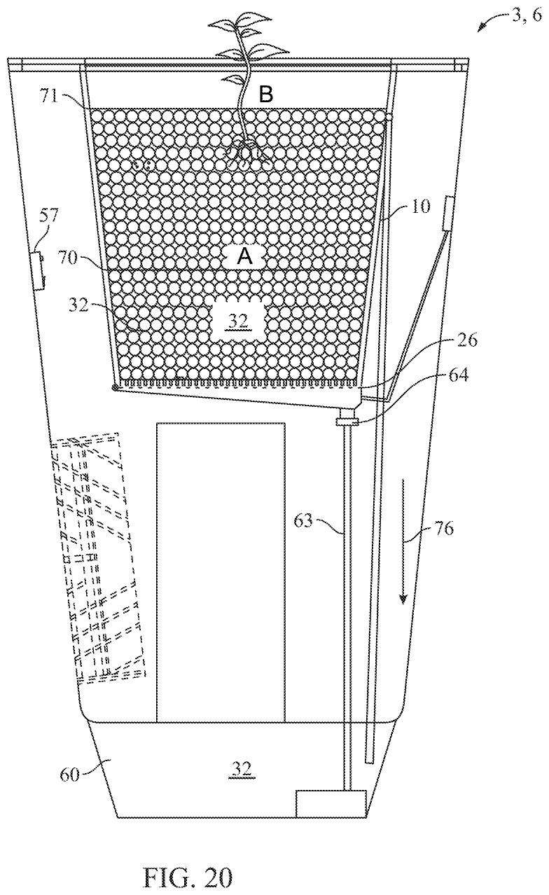

FIG. 20 shows the same variation of a plant air purifier in remoisturization (3), drainage sub phase (6), but where the unit has an electronically controlled water shut off valve (64). In this case the drainage process is initiated by a signal being sent from the circuit board (57), whereupon the electronically controlled shut off valve (64) is now opened and water (32) simply returns to the reservoir (60) via gravity as in FIG. 19. Level B (71) shows where the water level was at the initiation of the drainage phase. Level A (70) shows where the water is within the filter bed container (10) at a period of time while drainage is in progress. Again, water drains down through the filter container (10), through the porous bottom (26) of the filter container, through the water line (63) back to the reservoir (60), with an arrow (76) showing the direction of flow.

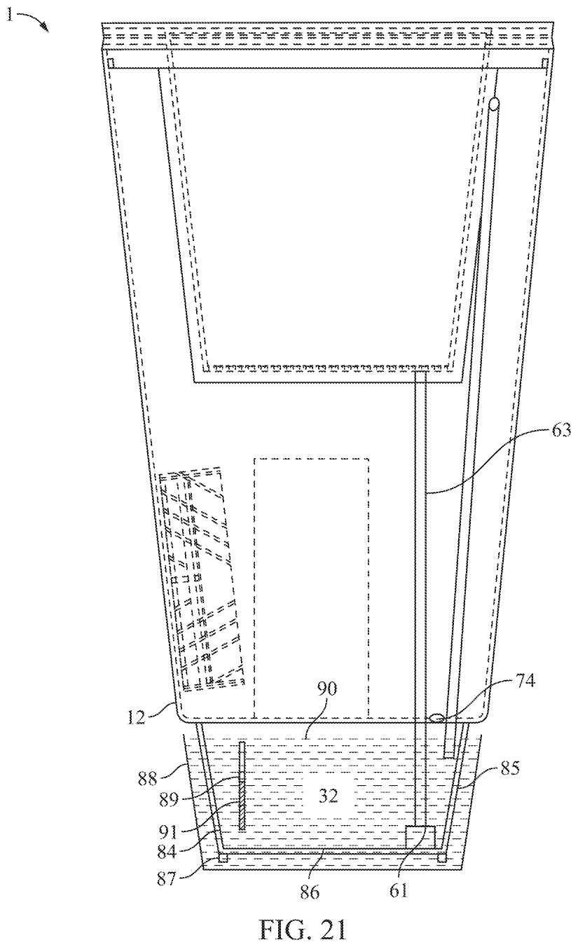

FIG. 21 shows embodiment 2 and embodiment 3's undercarriage (84). The undercarriage has columns (85) attaching to the bottom of the of the plant air purifier's outer housing (12) and it is supporting a hanging platform (86) on which a water pump (61) is resting. By stationing a platform on the undercarriage with a water pump, this is allowing for easier access to the water pump were it to malfunction. Plus, with this layout, the pump can easily stay connected to both the water line (63) and to its energy source and will not have to be disconnected were the water pump to be stationed in the reservoir alone. Please notice also that the columns extend down below the platform (86), thus providing legs (87) on the undercarriage so that the air purifier and undercarriage can easily sit on a piece of furniture without making more of a mess than absolutely necessary, especially during refilling of the detachable reservoir (88) when the air purifier and its undercarriage might well be removed from the reservoir; Having a detachable reservoir (88), is making the refilling process both simpler and easy. And in this figure the air purifier (1) and undercarriage (84) is being lowered into such a reservoir and has not quite come to rest for the undercarriage's legs (87) are not quite touching the bottom of the reservoir. In embodiment 1 a catch basin was part of the plant air purifier. This catch basin has been removed in this figure and a drainage hole (74) has been inserted in the bottom of the air purifier's outer housing so dripping water or moisture accumulation can be escaping and dropping down into the reservoir being stationed below when the air purifier is operating either in its air purification or remoisturizing phase. Meanwhile, the detachable reservoir (88) also has a window (89) for easier viewing of the reservoir's water level height (90) within, and part of the window is in red (91) so one knows that were the reservoir water level to drop into this area, the user should immediately refill the reservoir.

In summary: this figure demonstrates a method whereby the unit is further comprising a detachable reservoir making refilling of the reservoir easier.

Plus, it is further comprising a window on the detachable reservoir making for easier viewing of the water level in the reservoir itself.

Plus, the plant air purifier is further comprising an undercarriage on whose underhanging platform a water pump is being stationed, so effectuating easier access to that water pump if malfunctioning of the water pump is occurring.

And that undercarriage has legs that are being stationed below the platform so the undercarriage and the plant air purifier to which it is attached, are permitting placing the two on a piece of furniture without making more of a mess than is absolutely necessary as refilling of the reservoir is occurring.

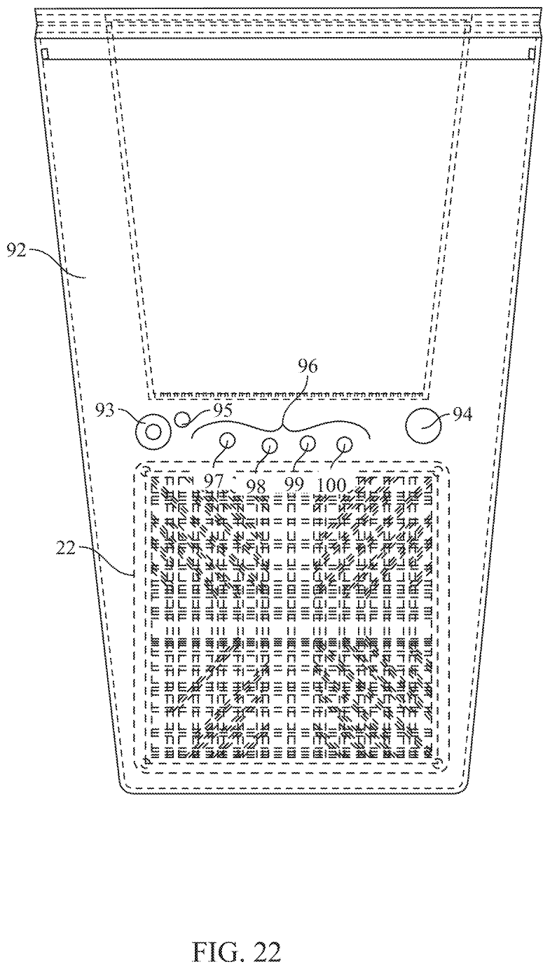

FIG. 22 shows the unit's front (92) of all three embodiments of the plant air purifier whose mechanism was shown in previous figures. The unit itself is rectangular and tapered. It has an infrared sensor (93) that is receiving signals from a remote controller and a vent (22) below it which diffuses the air coming out. Plus it has an on-off switch (94) that is turning on and turning off the fan(s) of the plant air purifier, a red light (95) which indicates that the fan(s) are shut off and a series of green LEDs (96) on the face of the plant air purifier that is alerting the user as to what speed the fan(s) are moving air through the filter bed container; Here by way of example we show, the first green light on the left as it operating at ¼ speed (97), the second green light indicates when it is lit that the fan(s) are operating at ½ speed (98), the third green LED when lit shows the fan(s) are operating at ¾ speed (99) and the fourth green LED when lit shows it is operating at full speed (100). More or fewer green LEDs might be used depending on how many gradients of speed are available and the fan(s) could be operating at different speeds depending on circumstances or the preference of the user.

Method claims utilizing some of these components are as follows:

The method further comprising an infrared sensor that is receiving signals from a remote controller;

The method further comprising an on-off switch which is turning on and off the fan(s) of the plant air purifier;

The method further comprising a series of LEDs on the face of the plant air purifier alerting the user as to what speed the fan(s) are drawing air through the filter bed container.

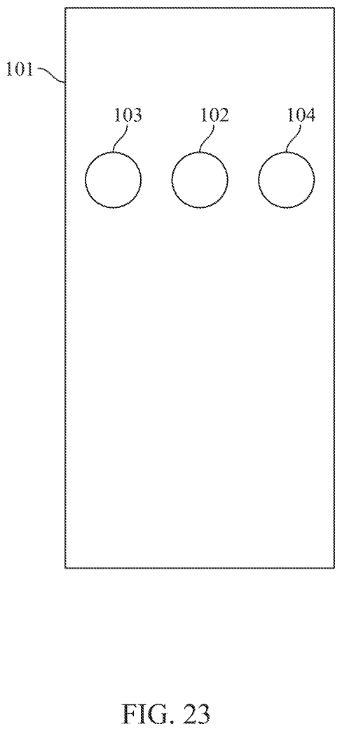

FIG. 23 shows a top down view of a remote controller (101) capable of regulating fan(s) speed and turning on and off of the plant air purifier from a distance. Here the center button (102) controls the on-off function for the fan(s). The left button (103) slows down fan speed and the right button (104) speeds up fan speed (104. Lay out of a remote controller might be different than here shown. Having a remote controller makes it easier to control the unit from a distance and provides greater ease of utilizing the plant air purifier. In a method claim this would read as follows:

A method further comprising a remote controller that is regulating fan(s) speed and turning on and off the plant air purifier from a distance.

The 3 embodiments are given by way of example and small variations in the configuration of the unit might occur by someone knowledgeable in the field but these should not alter the underlying principles on which the unit functions and for which it is being patented.

1. An air purifying device comprising:
a filter bed container further comprising filter material therein;
an air moving mechanism which is moving air through said filter material in the air purifying device during its air purifying phase;
water submerging at least some of the filter material during its remoisturization phase; and
a plant growing in the filter material.

2. The air purifying device of claim 1 further comprising water that submerges a majority of the filter material during the unit's remoisturization phase.

3. The air purifying device of claim 1 further comprising water that submerges at least 65% of the filter material during the unit's remoisturization phase.

4. The air purifying device of claim 1 further comprising water which submerges at least 75% of the filter material during the unit's re-moisturization phase.

5. The air purifying device of claim 1 further comprising water which submerges at least 90% of the filter material during the unit's remoisturization phase.

6. The air purifying device of claim 1 further comprising water which submerges all of the filter material during the unit's remoisturization phase.

7. The air purifying device of claim 1 further comprising a soaking phase.

8. The air purifying device of claim 1 further comprised porous filter material with hollow cavities therein.

9. (canceled)

10. (canceled)

11. (canceled)

12. The air purifying device of claim 1 further comprising an air diffusing vent.

13. (canceled)

14. The air purifying device of claim 1 further comprising a filter bed container with a porous bottom.

15. (canceled)

16. (canceled)

17. (canceled)

18. (canceled)

19. (canceled)

20. The air purifying device of claim 1 further comprising a circuit board with timer.

21. The air purifying device of claim 1 further comprising a reservoir.

22. (canceled)

23. (canceled)

24. The air purifying device of claim 1 further comprising a water pump.

25. (canceled)

26. (canceled)

27. (canceled)

28. The air purifying device of claim 1 further comprising a flap situated under the filter container's bottom.

29. (canceled)

30. The air purifying device of claim 1 further comprising an overflow weep hole attached to an overflow drainage line.

31. (canceled)

32. (canceled)

33. (canceled)

34. A method for treating indoor air by way of a plant air purifier with a filter container housing filter material, and for re-moistening the filter material of the plant air purifier; the method comprising passing air through the filter material in the plant air purifier by means of an air moving mechanism, during its air purifying phase, and submerging the filter bed while remoisturizing is taking place.

35. The method of 34 further comprising dividing up remoisturization into various sub phases: immersion and draining of the filter bed.

36. The method of claim 34 further comprising, during its re-moisturization phase, immersing, where the filter material within the filter container is progressively submerged by an increasing water level in the filter bed container.

37. The method of claim 34 further comprising a drainage sub phase where water in the filter container is draining away and progressively exposing more and more of the submerged filter material.

38. The method of claim 34 further comprising a soaking sub phase where filter material in the filter container is staying submerged for a given period of time.

39. (canceled)

40. (canceled)

41. (canceled)

42. (canceled)

43. (canceled)

44. The method of claim 34 further comprising an air diffusing vent which is causing less draft and making less noise than a straight directional vent.

45. (canceled)

46. (canceled)

47. (canceled)

48. (canceled)

49. (canceled)

50. (canceled)

51. (canceled)

52. The method of claim 34 further comprising an outer pot surrounding much of the filter bed container, that is allowing immersing, draining and soaking of the filter bed material within the filter container without the filter container being removed from the plant air purifier itself.

53. The method of claim 34 further comprising a reservoir sending water to the filter bed container for re-moisturizing the filter material within and receiving back excess water from the filter bed container during overflow or draining.

54. (canceled)

55. The method of claim 34 further comprising a water pump pumping water into the filter bed container as remoisturizing is taking place.

56. (canceled)

57. (canceled)

58. (canceled)

59. The method of claim 34 further comprising a flap being stationed under the porous bottom of the filter bed container so allowing both remoisturization of the filter material within the filter container and air purification to take place as well. Said method to include: raising the flap, thus making the bottom of the filter container impervious; filling the filter container with water, which as it is rising ever higher within the filter container is submerging more and more of the filter material; draining the filter container so more and more of the filter material is no longer being submerged; continuing draining of the filter container until all the water has drained away, lowering the flap stationed at the bottom of the filter container; moving air through the filter container by means of an air moving mechanism and so purifying indoor air.

60. The method of claim 58 further comprising an actuator that is both lifting and lowering the flap stationed under the porous bottom of the filter container.

61. The method of claim 34 further comprising coating each filter material granule, situated within the filter container, with a thin coat of moisture, so enabling the unit's acting as a wet scrubber, during the air purification process, while air is passing through the filter.

62. The method of claim 34 further comprising an overflow weep hole and drainage line that is taking water back to the reservoir so the water pump may be operating even during soaking.

63. (canceled)

64. (canceled)

65. (canceled)

66. (canceled)

67. (canceled)

68. (canceled)

69. (canceled)
